(19) United States
(12) Patent Application Publication
(10) Pub. No.: US 2016/0334648 A1
(43) Pub. Date: Nov. 17, 2016

(54) Optical Phase Shifter

(71) Applicants: Zeqin LU, Vancouver (CA); Kyle Jacob MURRAY, Vancouver (CA); Lukas CHROSTOWSKI, Vancouver (CA)

(72) Inventors: Zeqin LU, Vancouver (CA); Kyle Jacob MURRAY, Vancouver (CA); Lukas CHROSTOWSKI, Vancouver (CA)

(73) Assignee: Huawei Technologies Canada Co., Ltd., Kanata (CA)

(21) Appl. No.: 15/013,538

(22) Filed: Feb. 2, 2016

Related U.S. Application Data
(60) Provisional application No. 62/162,000, filed on May 15, 2015.

(51) Int. Cl. G02F 1/01; G02F 1/225

(52) U.S. Cl. CPC G02F 1/0147; G02F 1/0102; G02F 1/2257; G02F 1/011; G02F 2001/215

(57) ABSTRACT

An optical device includes first and second waveguide phase arms each having optically coupled parallel sections of waveguides, the parallel sections of each one of the waveguide phase arms being dissimilar to reduce crosstalk. The device further includes a tunable element for applying a phase shift to an optical signal traversing the first phase arm. The waveguides of the parallel sections may have dissimilar dimensions, e.g. may vary in width, thickness, or both. The waveguides adjacent the tunable element may be suspended and/or underetched to improve thermal isolation and accordingly reduce power consumption of the optical device.

### CROSS REFERENCE TO RELATED APPLICATIONS

This application claims the benefit of priority to U.S. Patent Application Ser. No. 62/162,000 entitled “Optical Phase Shifter” filed May 15, 2015, which is hereby incorporated by reference in its entirety.

### FIELD OF THE DISCLOSURE

The present disclosure relates to optical components.

### BACKGROUND

Optical switches that are low-cost, low-power, and of a compact size are important components in optical cross connects (OXC) and reconfigurable optical add-drop multiplexers (ROADM). Silicon-on-insulator (SOI) is a promising technology for developing optical switches due to its relatively large thermo-optic coefficient, high thermal conductivity and high contrast refractive index. In recent years, various thermo-optic switch configurations have been reported on the SOI platforms.

Phase shifters are used in many silicon photonic devices, including switches, modulators and tunable filters. Two common ways of implementing a phase shifter rely on an electro-optic effect, in which a change in the density of charge carriers affects the refractive index of silicon, and a thermo-optic effect, in which a temperature change affects the refractive index. Electro-optic phase shifters, while having fast operation, may require large footprints or high operating voltages and have an optical loss modulation associated with the phase shift. Thermo-optic phase shifters can achieve large phase shifts in small footprints with low operating voltages and without introducing optical loss modulation. However, they have slower response times and typically require more power for switching.

Much work has been devoted to reducing the power consumption of thermo-optic switches. Similarly, there is a need to improve the efficiency of optical phase shifters which are used in thermo-optic switches.

### SUMMARY

An aspect of the disclosure provides an optical device which uses thermo-optic properties of Silicon-On-Insulator, along with a tunable element, to provide an optical phase shifter with an improved power consumption profile. Accordingly, an optical device is disclosed which includes first and second waveguide phase arms each having an optically coupled parallel section of waveguides, the parallel sections of the waveguide phase arms being dissimilar to prevent crosstalk. The device further includes a tunable element for applying a phase shift to an optical signal traversing the first phase arm. In some embodiments, each optically coupled parallel section of waveguides forms a single lightpath. In some embodiments the waveguides of the parallel sections have dissimilar dimensions, which can vary in width, thickness and/or gap. In some embodiments the devices are fabricated to include parallel sections of dissimilar waveguides coupled together to form a single lightpath.

In accordance with embodiments of the present disclosure, there is provided an optical device comprising a coupler, first and second waveguides and a tunable element. The coupler is configured as an input power splitter and an output power combiner. The first and second waveguide phase arms are each folded in a plurality of turns to form arms with aligned sections. Optionally, there are two waveguide reflectors at the end of the phase arms. The tunable element is associated with the first phase arm. An embodiment is directed to a Michelson interferometer configuration with a suspended phase arm and densely folded waveguides of different widths to prevent crosstalk and for thermal efficiency.

Embodiments include a thermo-optic switch based on a Michelson interferometer configuration comprising a 2×2 adiabatic coupler which works as the input power splitter and output power combiner, two waveguide phase arms that are folded by a plurality of turns, and two waveguide loop mirrors working as reflectors at the end of the phase arms. The loop mirrors can be formed with a compact Y-branch and bent waveguides. One of the phase arms, designed for thermal tuning, is thermally isolated from the other arm with thermal undercut trenches. Some of the underlying Si substrate between the trenches is removed to form a suspended arm. A heating element is placed on top of the suspended arm for thermal tuning. Waveguide interaction length with the heater is increased by folding the waveguide multiple times. To increase the number of waveguides underneath the heater, the number of folded waveguides within the suspended region is maximized by designing waveguides with dissimilar widths.

In accordance with an aspect of the disclosure, there is provided an optical device including first and second waveguide phase arms each having optically coupled parallel sections of waveguides, the parallel sections of each one of the first and second waveguide phase arms being dissimilar to lessen crosstalk. The optical device further includes a tunable element for applying a phase shift to an optical signal traversing the first waveguide phase arm. In some embodiments, each optically coupled parallel section of waveguides forms a single lightpath. In some embodiments, waveguides of the parallel sections have dissimilar dimensions. In some embodiments, waveguides of the parallel sections have dissimilar dimensions which vary in one or more of gap, width, and/or thickness. In some embodiments, adjacent waveguides of the parallel sections have dissimilar dimensions. In some embodiments, the first and second waveguide phase arms comprise a plurality of tapered waveguides of different dimensions which are connected by loops, and the loops form transitions between the different dimensions. In some embodiments, there are N parallel sections and N−1 loops, with N being an odd integer greater than or equal to 3, such that input and output signals in each one of the first and second waveguide phase arms travel in a same direction. In some embodiments, the tunable element comprises a thermo-optic heater thermally coupled to the first waveguide phase arm. In some embodiments, the optical device is a silicon photonic device, wherein the thermo-optic heater comprises a metallic layer. In some embodiments, the first waveguide phase arm is suspended for better thermal isolation thereof. In some embodiments, the optical device in the region of the thermo-optic heater is underetched to improve thermal isolation of the first waveguide phase arm adjacent the thermo-optic heater. In some embodiments, the optical device further includes a coupler configured as both an input power splitter for splitting an input optical signal between the first and second waveguide phase arms, and as an output power combiner for recombining optical signals from the first and second waveguide phase arms to produce an output optical signal. In some embodiments, the optical device is configured as a Michelson interferometer, and wherein the first and second waveguide phase arms are terminated with waveguide reflectors at ends of the first and second waveguide phase arms. In some embodiments, the one or more couplers comprise a 2×2 coupler selected from a group consisting of an adiabatic coupler, a multimode interference (MMI) coupler, and a directional coupler. In some embodiments, the waveguide reflectors comprise loop mirrors. In some embodiments, the loop mirror comprises a compact Y-branch and a bent waveguide. In some embodiments, the optical device is configured as a thermo-optic switch. In some embodiments, the optical device further includes one or more couplers configured as input power splitters for splitting an input optical signal between the first and second waveguide phase arms, or as output power combiners for recombining the optical signal from the first and second waveguide phase arms to produce an output optical signal. In some embodiments the optical device is configured as a tunable Mach-Zehnder interferometer based optical switch. In some embodiments, the optical device is configured as a modulator. In some embodiments, the optical device is configured as a tunable Mach-Zehnder interferometer wherein at least adjacent waveguides of the parallel sections have varying widths.

### BRIEF DESCRIPTION OF THE FIGURES

Further features and advantages of the present disclosure will become apparent from the following detailed description, taken in combination with the appended drawings, in which:

FIG. 1 shows a schematic diagram of a phase shifter device according to an embodiment.

FIG. 2 is cross-section of the phase shifter region along line 2-2 of FIG. 1 for an underetched device.

FIG. 3 is similar to FIG. 2, but for a device without underetching.

FIG. 4 is a schematic diagram of a parallel waveguide structure according to an embodiment.

FIG. 5 is a schematic top view of another embodiment of a thermo-optic switch.

FIG. 6 is a cross-section of the suspended region along line 6-6 of FIG. 5;

FIG. 7 shows an enlargement of the inset from FIG. 5 illustrating an example region for the transition of dissimilar waveguides.

FIG. 8 illustrates a dissimilar waveguide structure and horizontal electric field profile of its modes according to an embodiment.

FIG. 9 illustrates maximum crosstalk between 220 nm thick waveguides with 1 mm pitch.

FIG. 10A shows the calculated spectra of the folded waveguide structure, and FIG. 10B shows the results according to an embodiment.

FIGS. 11A and 11B show example optical spectra of the underetched versions of embodiments of MZI devices 3 and 5, respectively, in the on and off state.

FIGS. 12A-D show the normalized transmission functions of the unetched and underetched versions of embodiments of MZI devices 2-5 as functions of the power applied to the thermal phase shifter, along with sinusoidal fits to the data.

FIGS. 13A-B show temporal responses of a) unetched, and b) underetched MZI switches respectively according to embodiments.

FIG. 14 shows the maximum coupling at 1550 nm between two dissimilar waveguides with widths of 400 nm, 500 nm, and 600 nm according to example Michelson Interferometer Configuration (MIC) devices.

FIGS. 15A-C show measurement results for MIC device 6. FIG. 15A shows optical transmission at switching ON and OFF states; FIG. 15B shows transmission at 1550 nm as a function of tuning power and FIG. 15C shows time-domain responses at 1550 nm.

FIGS. 16A and B show a performance comparison of the embodiment test devices. FIG. 16A shows switching power and FIG. 16B shows response time. In both, the dash lines are fitting curves for measurement results.

FIG. 17 is a 3D heat transfer simulation for the suspended arm of MIC device 6 according to an embodiment. The arrows indicate the heat flux. The size of the arrows indicates the magnitude of the heat flux.

It will be noted that throughout the appended drawings, like features are identified by like reference numerals.

### DETAILED DESCRIPTION

While power budget has been continuously reduced, published works have not been able to demonstrate power levels that satisfy high density photonic network requirements. Solving power budget issues will create new opportunities for large switch matrix application.

A number of methods for increasing the efficiency of thermal phase shifters have been proposed. These methods include improving thermal isolation by removing the material surrounding the phase shifters and folding a waveguide many times under a heater to increase the optical interaction length within the heated region. It is pointed out that semiconductor waveguides are fabricated, but the term folding is used to describe the shape that would be achieved by folding a single fiber.

When folding a waveguide under a heater, the waveguide spacing between each fold is limited by the evanescent coupling of light between adjacent waveguides. When adjacent waveguides are identical to each other, the coupling of power between them is resonant, and a complete transfer of power can be achieved over a characteristic coupling length. The coupling length is strongly dependent on the waveguide spacing, and so the spacing must be chosen such that the power coupling over the length of the device is sufficiently small for the desired application. This need for a sufficiently large spacing limits the achievable density of waveguide routing and therefore limits the number of times a waveguide can be folded under a heater and thus subsequently limits the power efficiency gains which can be achieved. In other words, crosstalk occurs when parallel waveguides are close to each other. This crosstalk can be reduced by sufficiently spacing apart the parallel waveguides. However, devices with sufficient separation of the waveguides to reduce crosstalk to acceptable levels have an increased size both in terms of footprint and heater size.

Presented below is a configuration in which different waveguide dimensions in the parallel sections (e.g. folds) of the phase shifter are used to overcome the limits imposed by the requirement for sufficiently large spacing discussed above. The evanescent coupling between dissimilar waveguides does not achieve phase matching. Therefore, the power coupling between dissimilar waveguides is not complete. For a given waveguide spacing, if the mismatch between adjacent waveguide widths is sufficiently large, then the power coupling can be made negligibly small over any coupling length. Without the need to have a large spacing, the density of waveguide folding under a heating element can be increased dramatically, and the efficiency of thermal heaters can be correspondingly improved.

Improved phase shifters which can either be used as modulators or form thermo-optic switches are disclosed. Some embodiments utilize a Mach-Zehnder interferometer (MZI) configuration, whereas other embodiments utilize Michelson interferometer configurations. Each use first and second waveguide phase arms. Each phase arm has a plurality of optically coupled parallel sections, which can be described as zigzag folded waveguides. Each device also includes a tunable element (for example a heater) for applying a phase shift to an optical signal traversing the first phase arm. The folded waveguides are used to increase the waveguide interaction length with the heated region. The parallel sections of the waveguide phase arms are configured to be dissimilar to prevent crosstalk. In some embodiments, thermal isolation of the tuning regions is used to further reduce switching power. In some embodiments, suspended structures are used to achieve better thermal isolation. While MZI and Michelson interferometer configurations are discussed, it should be appreciated that other configurations can be used.

Additionally, dissimilar waveguides can increase waveguide routing density in photonic circuits. Dissimilar waveguide routing may also be used for dense mode division multiplexing with gaps between adjacent waveguides as small as 100 nm.

Embodiments will be discussed in which the thickness is the same for all waveguides and the width varies. However, other embodiments could use different thicknesses and the same width, or have both different (in fact it is believed that varying both would allow for designs with the best performance). Other embodiments can vary the gap between waveguide sections.

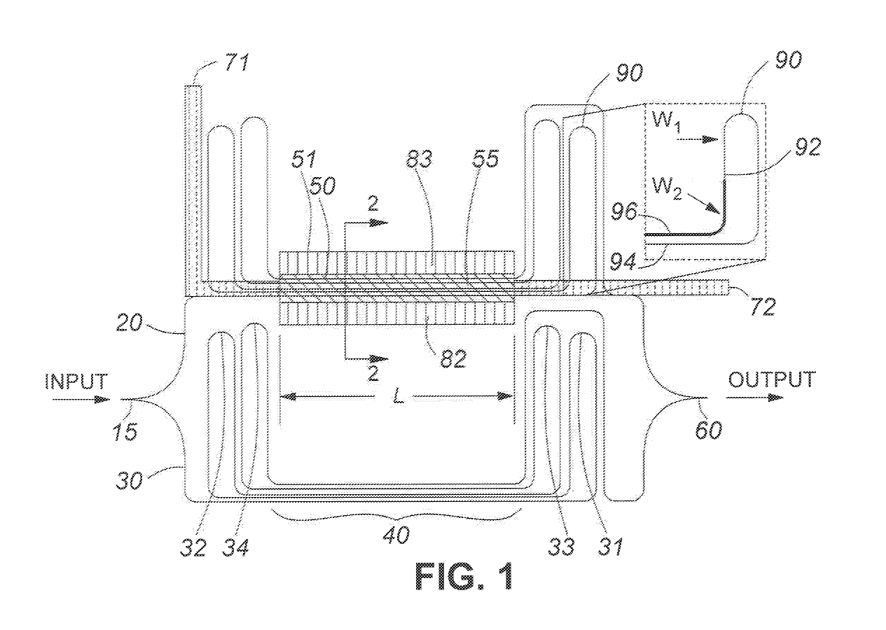

FIG. 1 shows a schematic diagram of an optical device implemented using an MZI configuration, according to an embodiment. Input light is split by a coupler, for example a 50-50 adiabatic splitter 15, into a first phase arm 20 and a second phase arm 30. The two phase arms are similar in configuration, except the first (upper) phase arm 20 passes through a heater 55. Each phase arm includes a dense dissimilar waveguide routing region 40, which in this illustration is the parallel section 40 of 5 sections of waveguides of length L. Each waveguide is folded 4 times. As mentioned above, some embodiments are directed to fabricated semiconductor waveguides, which would be fabricated and not actually folded. Looking at light traversing the second (lower) phase arm 30, it can be seen that the light would pass through first parallel section at 40 before looping back via a first fold 31 to loop back at a second fold 32 to traverse the parallel section 40 again before looping back at fold 33 and then fold 34 before recombining with the light from the first phase arm at coupler 60 at the output of the device.

Accordingly, it can be seen that there is a single lightpath for each phase arm, with each phase arm including parallel sections of waveguides (5 are illustrated, but this number can vary). In general, the light travelling along the upper MZI arm 20 passes N times through a thermal phase shifter 51 before recombining with the light from the other arm at the device output, wherein N=5 in the embodiment shown.

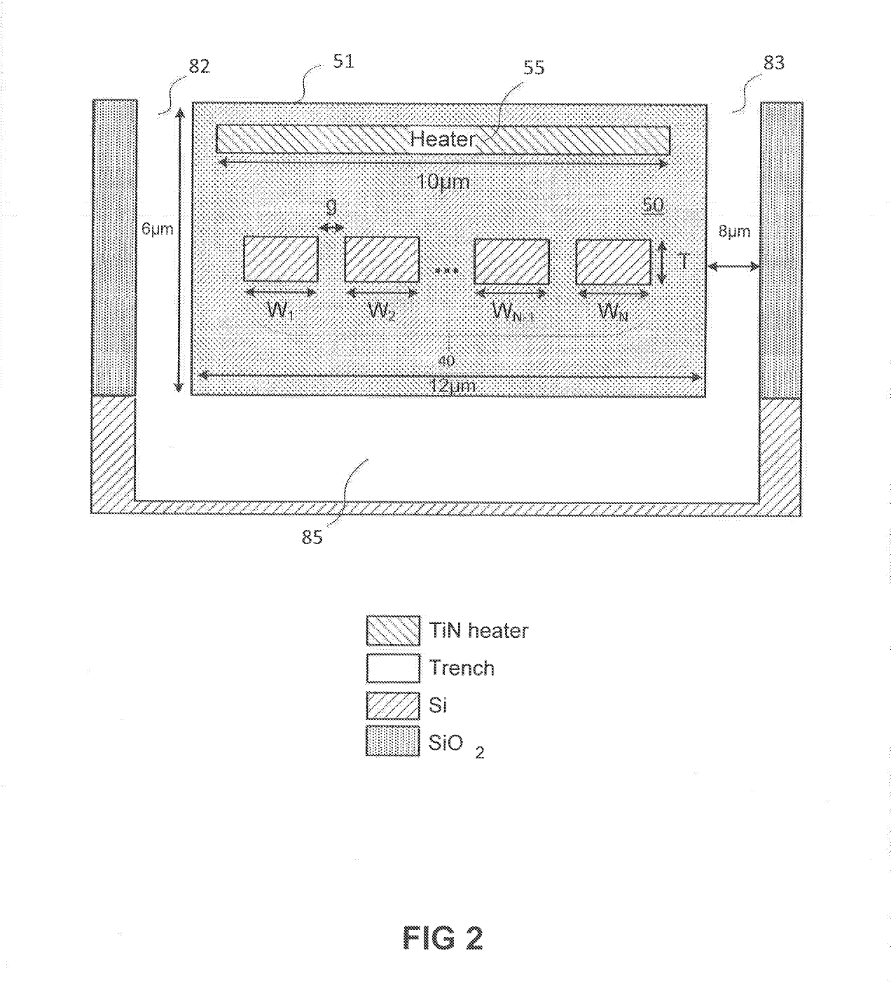

The thermal phase shifter 51 comprises a suspended structure 50, which may be formed from SiO₂, and the heater 55 of length L which heats the parallel section of waveguides 40 of the first phase arm 20. The heater 55 is connected to routing metal strips 71, 72 which provide the input current to control the heater 55. In this embodiment, the parallel section 40 of the waveguides and the heater 55 forms the suspended structure 50, which is thermally separated from the surrounding portions of optical device. In this embodiment, the suspended structure 50 is formed by etching the surrounding portions of the SiO2 to form trenches 82, 83, and in the case of an underetched device, the area underneath 85, which can be seen more clearly in FIG. 2.

It is useful to increase the number of waveguides within the parallel section in order to increase the length of optical interaction with the heater. Prior art devices have accomplished this by folding a single waveguide multiple times to form a parallel section under the heater. However, as discussed above, parallel waveguides can cause crosstalk. To prevent parallel waveguides from causing crosstalk, waveguides with different dimensions are utilized in the parallel sections. While it is known that crosstalk can be reduced between parallel waveguides of different lightpaths by utilizing different waveguide widths, embodiments of the present invention now extend this principle for parallel waveguide sections of a single lightpath.

As shown in the inset of FIG. 1 (and as can be seen in FIG. 2), the widths of the waveguides of the parallel sections are designed to be dissimilar with widths w₁, w₂, . . . , W_{N}, in order to obtain dense routing while keeping crosstalk between the waveguides sufficiently small. The evanescent coupling between the dissimilar waveguides does not achieve the phase matching condition so that power transfer between the waveguides is negligible.

It is noted that the term “parallel section” is used for ease of explanation. For optimal performance with minimum footprint, it is desirable (but not necessary) for the waveguides to be substantially parallel. If the waveguides are not parallel, then they will be diverging (in the region of the heater), thus increasing the footprint and reducing thermal efficiency, or converging and increasing crosstalk. Both are undesirable, but many applications can trade-off some degree of either in order to reduce the cost of optimally aligning the waveguides. Accordingly, it is to be understood that, in some embodiments, the parallel sections of waveguides can allow some divergence from parallel, and the term “parallel section” shall be construed to allow for such a divergence.

In one embodiment, tapered waveguides are used for a transition 92 between the dissimilar waveguide portions of the phase arms, as shown in the insert of FIG. 1. As illustrated, a first waveguide 94 having width W₁ is inserted into a second waveguide 96 having width W₂ at the transition 92 in a loop 90. The tapered waveguides are shown to transition at the loops in order that the aligned portions not cause crosstalk. The transition need not necessarily be part of the loop. However, other mechanisms for coupling dissimilar waveguides can be used. For example, in another embodiment, a series of N waveguides of different widths are joined by conventional loops. This may result in transitions that occur when the waveguides are still parallel. This may introduce a small amount of crosstalk in the portions where the waveguides have the same widths and are parallel. However, such a small amount of crosstalk may be acceptable for some applications.

FIG. 2 is a cross-section of the phase shifter region along line 2-2. In FIG. 2, the heater 55 has a width of 10 μm. The heater 55 is used to apply a temperature change to the waveguides to induce a thermo-optic phase shift. In some embodiments, the heater 55 is a metallic heater. In some embodiments, the optical device is a silicon photonic device comprising SiO₂ housing for silicon waveguides. In some embodiments, the heater 55 is formed from a deposited metallic layer, for example TiN. The dimensions of the waveguides are as follows. Each of the N waveguides has a thickness T of 220 nm, a width, Wᵢ, i=1, 2 . . . N, and all waveguides are separated by a common gap g. The device includes passages or trenches 82, 83, which can be oxide openings or etched to provide thermal isolation. In some embodiments, the silicon substrate (which may be formed from SiO₂) has been removed (e.g., by underetching area 85) to form the suspended bridge structure 50 having a width of 12 μm to increase thermal isolation. To avoid crosstalk, the parallel sections of the waveguide phase arms have dissimilar dimensions. In the embodiments discussed, the waveguides have the same thickness and are made dissimilar by varying the width. However, dissimilar waveguides which can vary in one or more of gap, width, and/or thickness can be used.

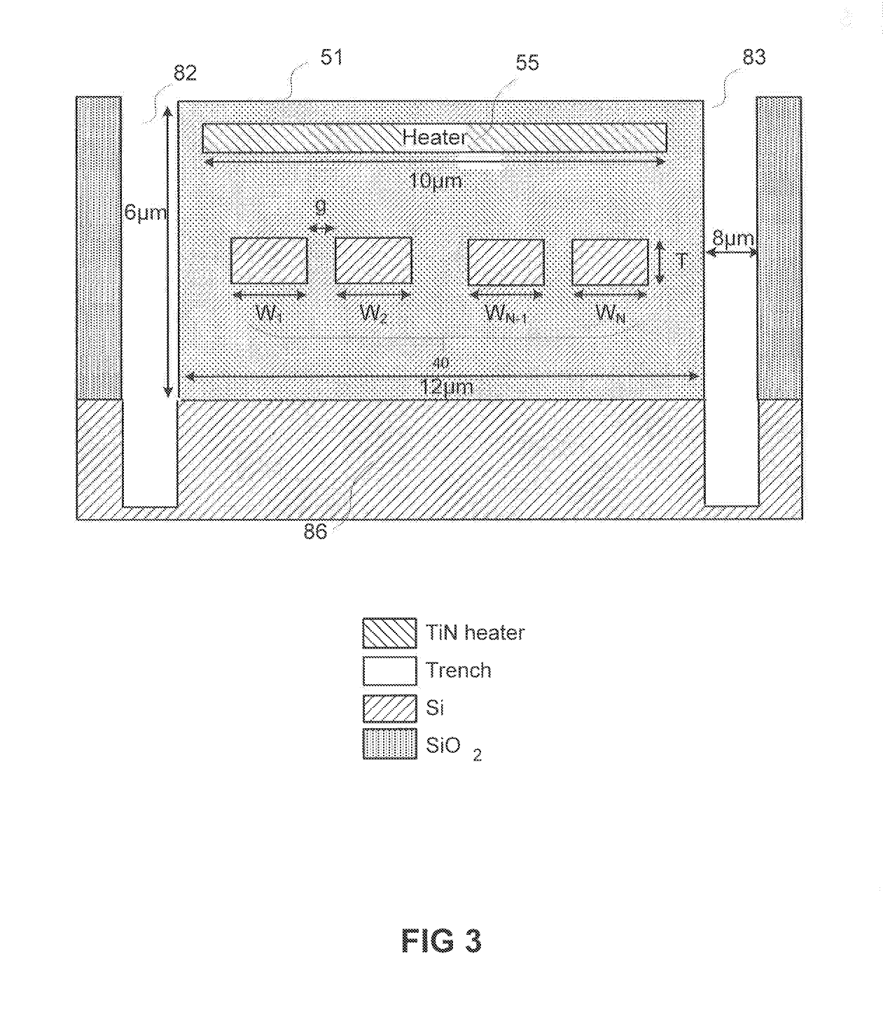

FIG. 3 is similar to FIG. 2, but illustrates a similar cross section for a device without underetching. FIG. 3 can be thought of as a view of the device of FIG. 2 before underetching of the area 85, showing the unetched silicon substrate 86 underneath the waveguides. As the device in FIG. 3 is not underetched, the reference numeral 50 is removed as it is not a suspended structure, but it still has some measure of thermal isolation from the rest of the device via trenches 82, 83.

It should be noted that embodiments can be configured with a number of variations for providing thermal isolation of the waveguides in the vicinity of the heater, including:
i) no etching of trenches or underetching;
ii) isolation trenches (82,83) formed by removal of the oxide and/or substrate horizontally adjacent to the waveguides; and/or
iii) removal of the substrate 86 underneath the waveguides to under-etch the area 85

The optical device shown in FIG. 1 could be implemented as a modulator, attenuator, switch, etc.

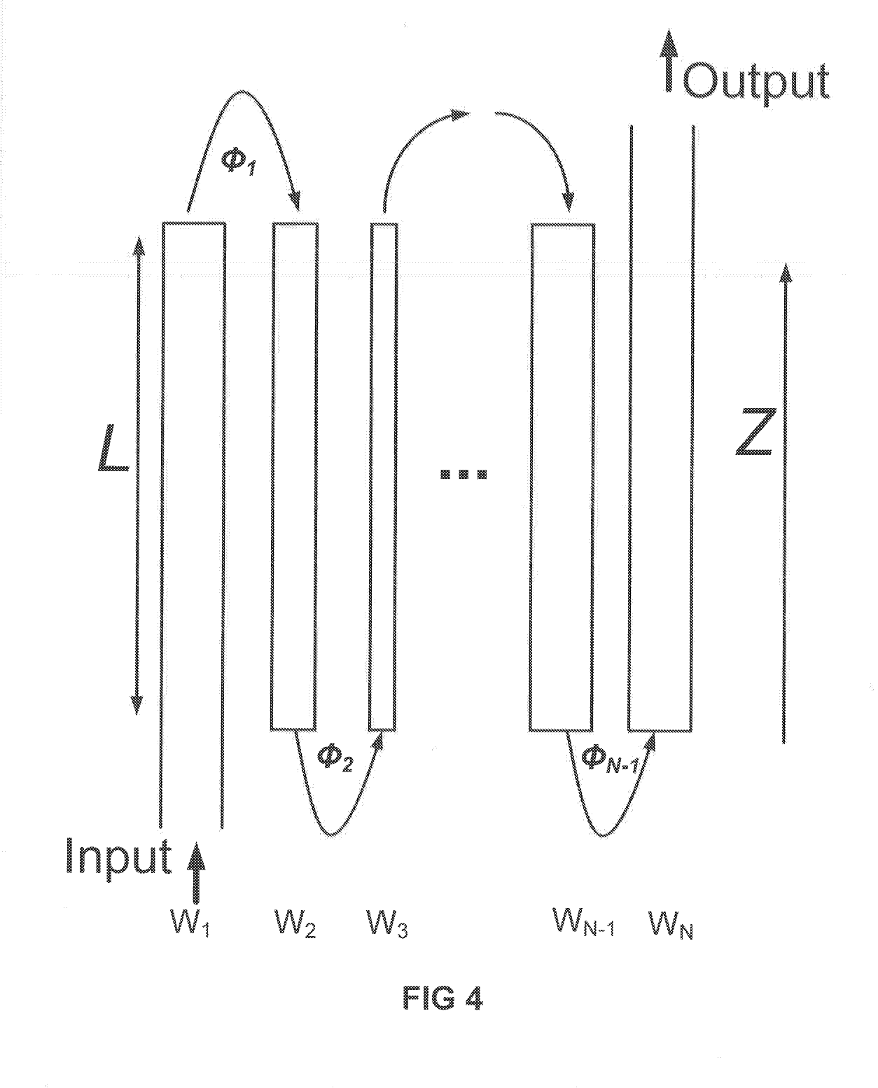

FIG. 4 shows a schematic of the parallel section of length 1, for N waveguides forming a single lightpath. As can be seen, the dimensions of each waveguide in the parallel section varies with widths Wₘ, for m=1, 2 . . . N. Light is injected into the waveguide at the input and propagates through each waveguide through loops (not shown), such that the transmitted light can be measured at the output from waveguide N. An odd number of waveguides is considered so that the input and transmitted light are travelling in the same direction Z.

Another embodiment provides a phase shifter which can be used in an optical switch that incorporates a Michelson interferometer configuration, suspended structures, and parallel waveguides to further reduce the power consumption of SOI thermo-optic switches.

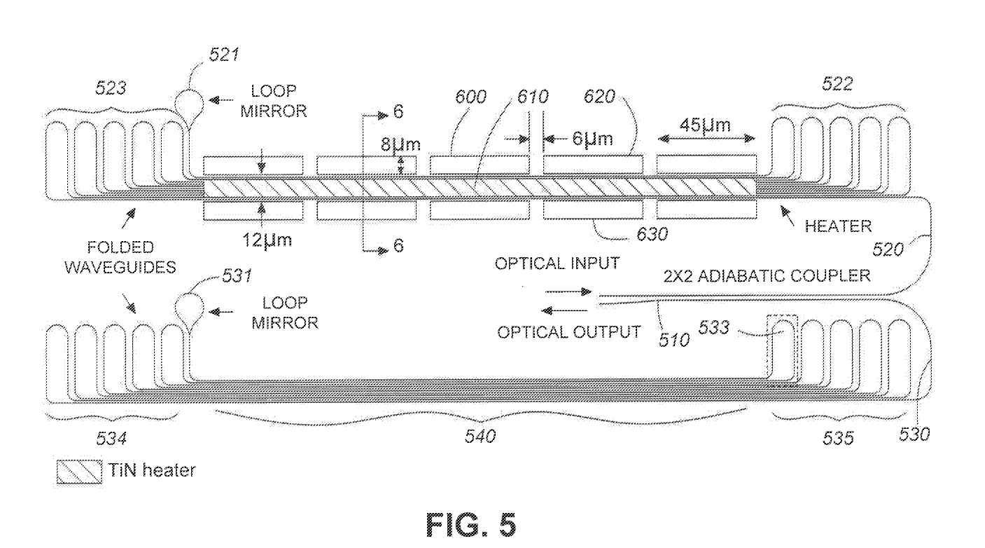

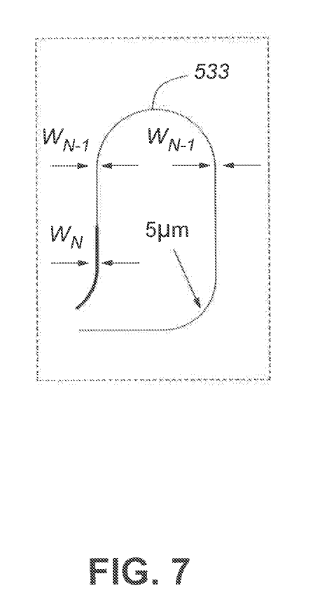

A top schematic view of a Michelson interferometer thermo-optic switch according to an embodiment is shown in FIG. 5. The embodiment includes a 2×2 adiabatic coupler 510, which functions as an input power splitter and output power re-combiner. However, other couplers could be used, including MMI, directional couplers, etc. The input light is split between two waveguide phase arms, namely first phase arm 520 and second phase arm 530. Both phase arms include a plurality of folds or loops 522, 523, 534, 535 to produce optically coupled parallel sections of waveguide 540, and two waveguide loop mirrors 521, 531 functioning as reflectors at the end of the phase arms. An example look 533 will be discussed below with reference to FIG. 7. In an embodiment, the loop mirrors 521, 531 are formed using a compact Y-branch and bent waveguides. However, other types of loop mirrors can be used, including those formed from an adiabatic or other splitter instead of a Y-branch.

The first phase arm includes a series of 5 suspended structures 600, each being 45 μm long and separated by 6 μm, through which a heater 610 is disposed.

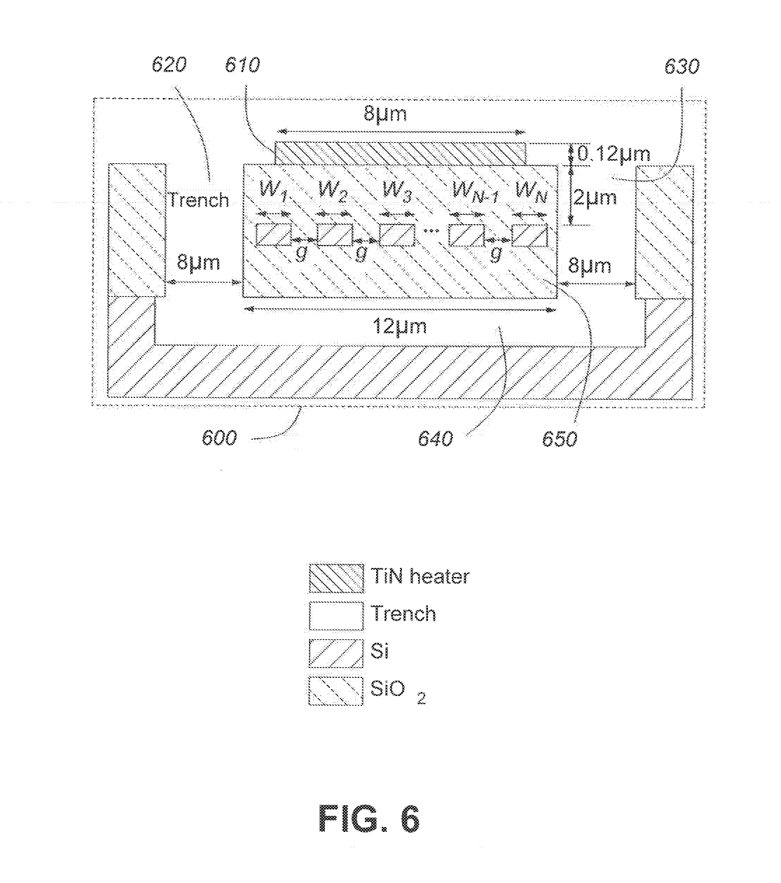

FIG. 6 is a cross-section through one of the suspended structures 600 along line 6-6 of FIG. 5. The heater 610 having e.g. a width of 8 μm and length L is used to apply a temperature change to the waveguides to induce a thermo-optic phase shift. In some embodiments, the heater 610 is a metallic heater. In some embodiments, the optical device is a silicon photonic device comprising SiO₂ housing for silicon waveguides. In some embodiments, the heater 610 is formed from a deposited metallic layer, for example TiN. The dimensions of the waveguides are as follows. Each of the N waveguides has a thickness T of 220 nm, a width Wᵢ, i=1, 2 . . . N, and all waveguides are separated by a common gap g. The device includes passages or trenches 620, 630, which can be oxide openings or etched to provide thermal isolation. In some embodiments, the silicon substrate (which may be formed from SiO₂) is removed (e.g., by underetching the area 640) to form a 12 μm wide suspended bridge 650 to increase the thermal isolation.

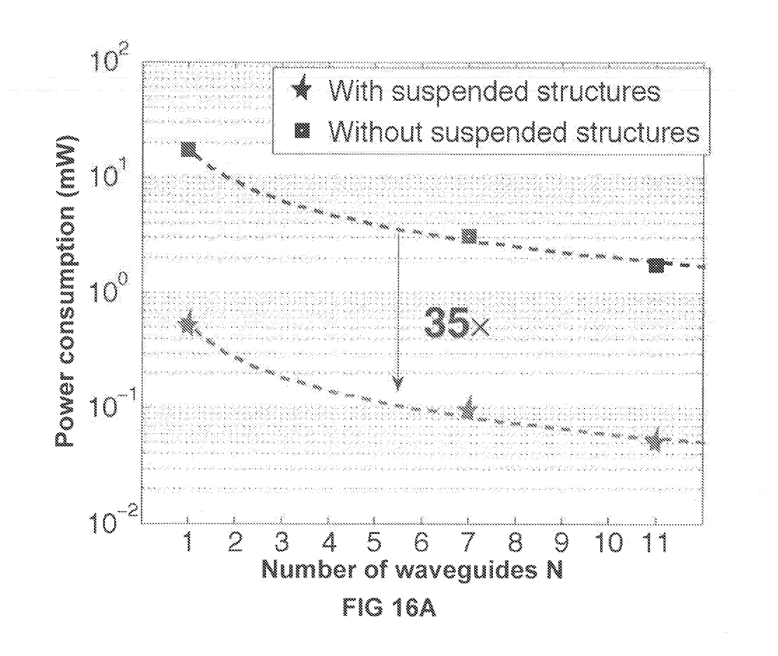

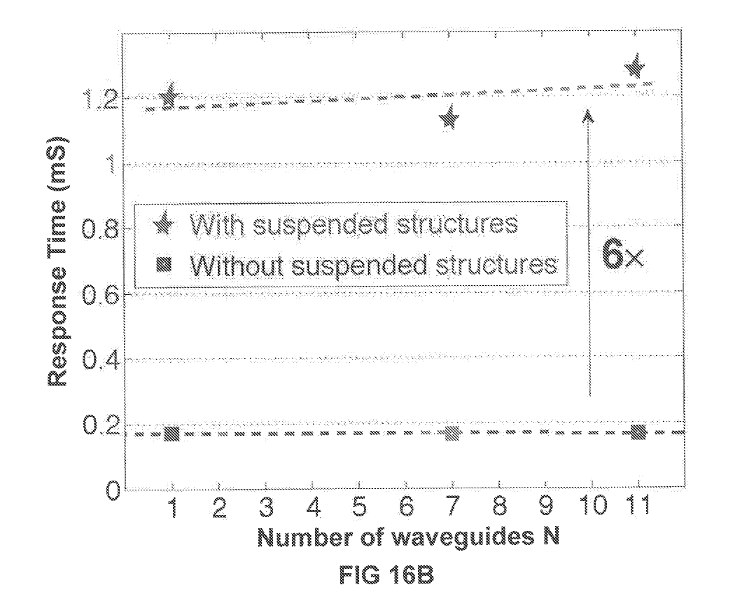

Accordingly there are a number of possibilities, including:
i) The parallel waveguide section is thermally isolated at both sides (620, 630) and underneath 640, as illustrated in FIG. 6, which will be referred to as a suspended structure in FIGS. 16A and 16B;
ii) The parallel waveguide section is thermally isolated at the sides 620, 630 but not underneath 640; and
iii) The parallel waveguide section is not thermally isolated at the sides or underneath (which will be referred to as without suspended structures in FIGS. 16A and 16B).

To reduce crosstalk, the parallel sections of the waveguide phase arms may have dissimilar dimensions. In the embodiments discussed, the waveguides have the same thickness and are made dissimilar by varying the width. However, dissimilar waveguides which can vary in width, thickness or both can be used. Further, the gap between the waveguides can also be varied.

FIG. 7 illustrates the inset from FIG. 5. FIG. 7 illustrates an example loop 533 and the transition between dissimilar waveguides, wherein the lightpath transitions from a waveguide of width W_{N-1} to a width of W_{N}, using for example tapered waveguides. The radii of the waveguide bends are 5 μm. The tapered waveguides are shown to transition at the loops in order that the aligned portions not cause crosstalk however, as stated above, other mechanisms for coupling dissimilar waveguides can be used.

Cross coupling in Mach Zehnder interferometers utilizing folded waveguides is modeled to show that the ripple in the through spectrum of the switch is an appropriate metric for measuring the degree of crosstalk present.

A theoretical model involving Coupled Mode Theory of Dissimilar Waveguides will now be discussed. In this section, the crosstalk between a pair of dissimilar waveguides is computed. To achieve this, a notion of the power in a waveguide is defined by projecting the optical field of the two waveguide system onto the field of a single waveguide mode. A change of basis from the two-waveguide eigenmode basis is discussed, in which the propagation is simple to describe, to a basis in which the power in each waveguide is simple to compute. In this basis, the propagation is more complicated due to the appearance of coupling between modes.

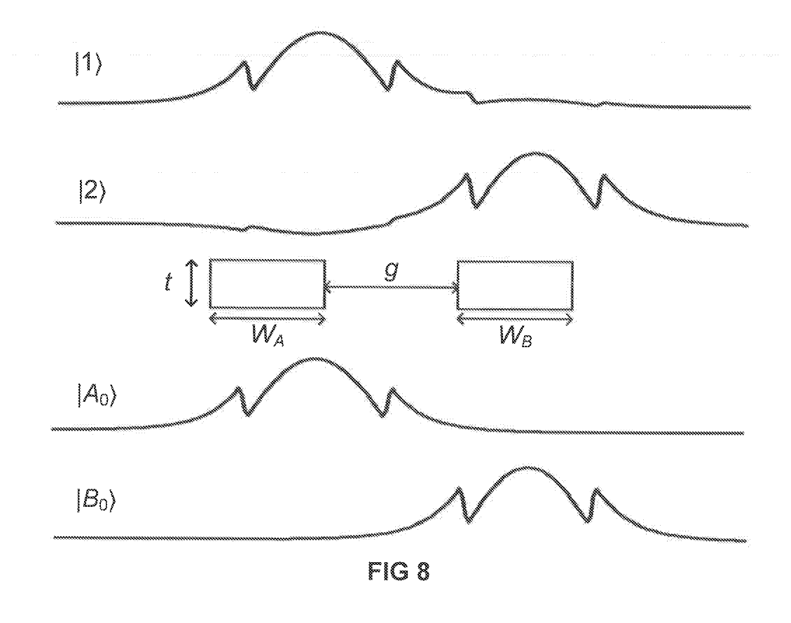

FIG. 8 illustrates dissimilar waveguide structure and horizontal electric field profile of its modes. Modes |1 [symbol] and |2 [symbol] are the modes of the two-waveguide structure. Modes |A₀> and |B₀ [symbol] are the modes when only waveguide A or waveguide B are present respectively.

Consider two parallel waveguides, denoted as waveguides A and B, of thickness t and widths W_{A} and W_{B} separated by a gap, g, as shown in FIG. 8. The two waveguide system has transverse electric (TE) eigenmodes |1 [symbol] and |2 [symbol] , each normalized to unit power, with propagation constants k₁ and k₂ respectively. Waveguides A and B considered in isolation have eigenmodes |A₀ [symbol] and |B₀ [symbol] , respectively, the inner product:

[symbol]

ψ₁|ψ₂ [symbol] =¼[∫E₁×H*₂·dS+∫E*₂×H₁·dS] (1)

where Eᵢ and Hᵢ, i=1,2 are transverse electric and magnetic field profiles of two modes |ψ₁ [symbol] and S is the plane normal to the propagation direction, we can decompose the single waveguide state |A₀ [symbol] in terms of the two-waveguide eigenmodes:

|A [symbol] = [symbol] 1A₀ [symbol] |1 [symbol] + [symbol] 2|A₀ [symbol] |2 [symbol] . (2)

The difference between |A [symbol] and |A₀ [symbol] is due to not including the complete set of radiation modes in the mode decomposition. Define the power normalized state

|A̅ [symbol] =\sqrt{ [symbol]A| [symbol]}/|A [symbol] (3)

and |B̅ [symbol] similarly. A general superposition in the |1 [symbol] and |2 [symbol] basis is then denoted as a vector with the components a and b:

$$V = [ \begin{matrix}a \\ b\end{matrix} ] = a \vert 1 〉 + b \vert 2 〉 . \qquad ( 4 )$$

Evolution along the propagation direction, z provides:

$$\frac{d V}{d 𝓏} = i [ \begin{matrix}{k}_{1} & 0 \\ 0 & {k}_{2}\end{matrix} ] V ≡ iPV . \qquad ( 5 )$$

Performing a change to the |Ā [symbol] ,B̅ [symbol] basis with components c and d,

$$\begin{matrix}\overline{V} = [ \begin{matrix}c \\ d\end{matrix} ] = c \vert \overline{A} 〉 + d \vert \overline{B} 〉 & ( 6 ) \\ V = [ \begin{matrix}\frac{〈 1 \vert {A}_{0} 〉}{\sqrt{〈 A \vert A 〉}} & \frac{〈 1 \vert {B}_{0} 〉}{\sqrt{〈 B \vert B 〉}} \\ \frac{〈 2 \vert {A}_{0} 〉}{\sqrt{〈 A \vert A 〉}} & \frac{〈 2 \vert {B}_{0} 〉}{\sqrt{〈 B \vert B 〉}}\end{matrix} ] \overline{V} ≡ M \overline{V} , & ( 7 )\end{matrix}$$

The new evolution follows:

$$\frac{d \overline{V}}{d 𝓏} = {iM}^{- 1} PM \overline{V} ≡ i \overline{P} \overline{V} . \qquad ( 8 )$$

It should be noted that since in general MA is not unitary the inner product is

V^{†}V=V̅M^{†}MV̅≠V̅^{†}V̅ (9)

and the sum of the squares of the norms of the components of V̅ is not in general a conserved quantity. Nevertheless, we will identify the square of the norms of the components of V̅ with the informal notation of the power contained in each waveguide. More precisely, the square of the norm of the first component of V̅ is the power that would be transmitted into waveguide A if waveguide B were abruptly terminated and the squared norm of the second component has a similar interpretation.

Considering a situation where at z=0 the waveguide system is excited in the state |Ā [symbol] , then one can consider the power coupled to waveguide B over some length L as the squared norm of the amplitude of |B̅ [symbol] at z=L. In the special case where waveguides A and B are identical, the power is transferred completely from waveguide A to waveguide B over a characteristic length, L_{c}=π/(k₁−k₂), depending on the dimensions of the waveguides and their separation [11]. Thus to limit the crosstalk between the waveguides over their length then the separation between the waveguides should be made large enough such that L_{c}>>L.

If the two waveguides are not identical, then the power is still periodically coupled between the waveguides, but the transfer of power is incomplete. The maximum crosstalk, CT, can then be computed as the maximum value of the squared norm of the second component of V̅ in the solution to Eq (8):

$$\begin{matrix}\overline{V} ( 𝓏 ) = {M}^{- 1} {e}^{i {P}_{𝓏}} M \overline{V} ( 0 ) = {M}^{- 1} {e}^{i {P}_{𝓏}} M [ \begin{matrix}1 \\ 0\end{matrix} ] & ( 10 ) \\ \begin{matrix}CT = {max}_{z} ( {\vert [ 0 \; 1 ] \overline{V} ( 𝓏 ) \vert}^{2} ) \\ = {max}_{z} ( {\vert [ 0 \; 1 ] {M}^{- 1} {e}^{i {P}_{𝓏}} M [ \begin{matrix}1 \\ 0\end{matrix} ] \vert}^{2} ) \\ = 4 \cdot \frac{〈 B \vert B 〉}{〈 A \vert A 〉} \cdot \frac{{\vert 〈 1 \vert {A}_{0} 〉 〈 2 \vert {A}_{0} 〉 \vert}^{2}}{{\vert 〈 1 \vert {A}_{0} 〉 〈 2 \vert {B}_{0} 〉 - 〈 1 \vert {B}_{0} 〉 〈 2 \vert {A}_{0} 〉 \vert}^{2}}\end{matrix} & ( 11 )\end{matrix}$$

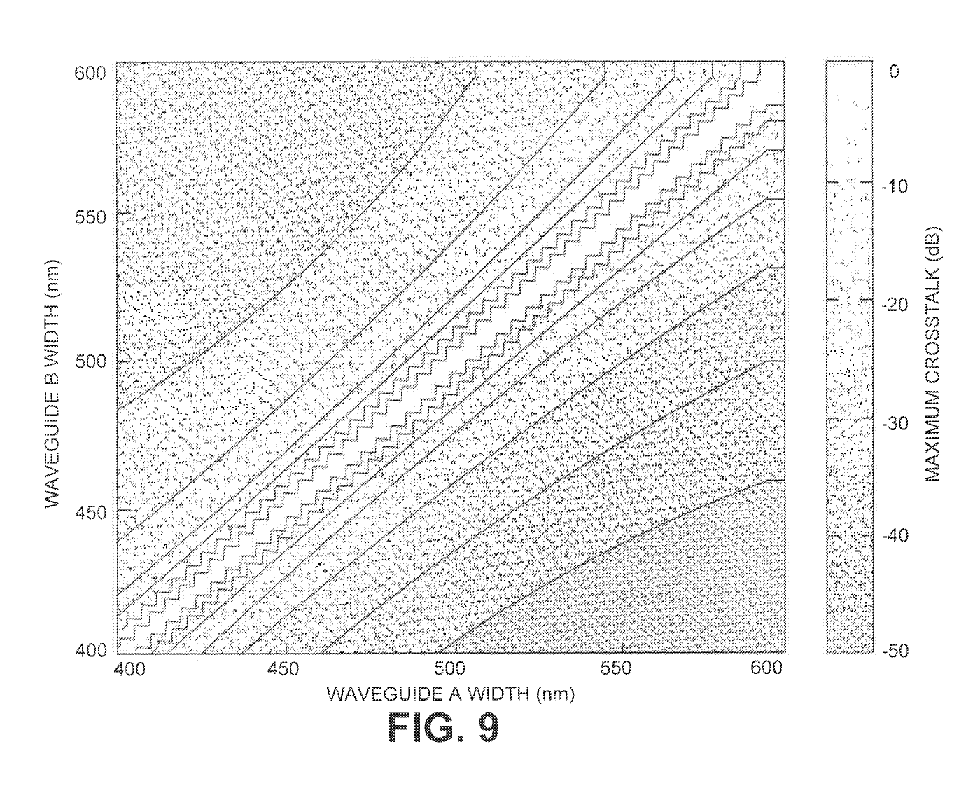

FIG. 9 shows the computed maximum crosstalk for waveguides with a fixed center to center separation of 1 μm and thickness 220 nm as the widths of the waveguides are varied for a wavelength of 1550 nm. The modes and propagation constants were computed using a numerical mode solver. It can be seen that by making the waveguide widths sufficiently different the crosstalk can be limited for small separations regardless of the length of the coupler. The asymmetry of the crosstalk under interchange of waveguides A and B is due the difference between first exciting state |A [symbol] , then later measuring state |B [symbol] , and first exciting state |B [symbol] then later measuring state |A [symbol] . This difference is due to the non-orthogonality of |A [symbol] and |B [symbol] for dissimilar waveguides.

Referring back to FIG. 4, to model the propagation, a tight-binding coupled mode model is utilized where only the coupling between nearest neighbor waveguides is considered. The propagation is described by the differential equations:

$$\begin{matrix}\frac{d {\overline{V}}_{m}^{+}}{d 𝓏} = {a}_{m} {\overline{V}}_{m}^{+} + {b}_{m} {\overline{V}}_{m - 1}^{+} + {c}_{m} {\overline{V}}_{m + 1}^{+} & ( 12 ) \\ \frac{d {\overline{V}}_{m}^{-}}{d 𝓏} = - {a}_{m} {\overline{V}}_{m}^{-} - {b}_{m} {\overline{V}}_{m - 1}^{-} - {c}_{m} {\overline{V}}_{m + 1}^{-} ; \\ where \\ {\overline{V}}_{m}^{+} and {\overline{V}}_{m}^{-} , m = 1 , 2 , … N , & ( 13 )\end{matrix}$$

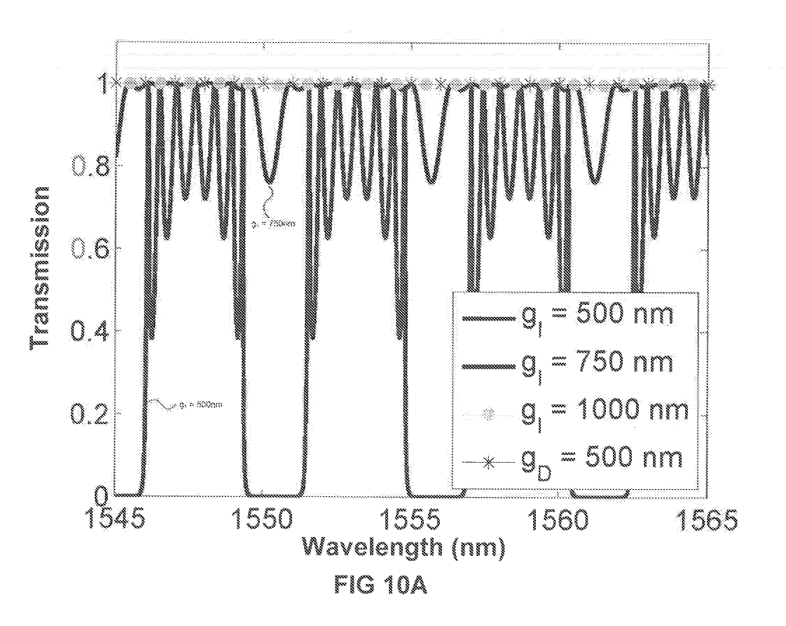

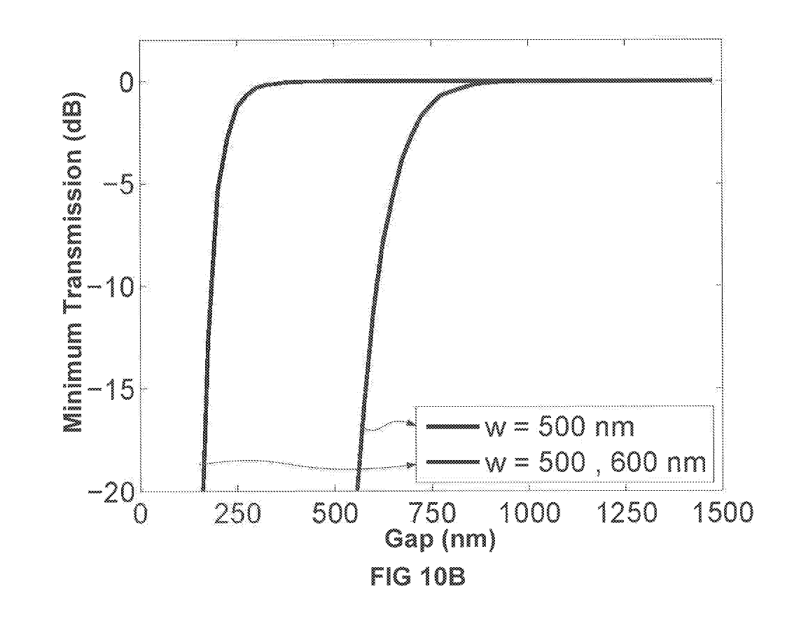

are the amplitudes of the modes in waveguide j travelling in the positive and negative z directions. Here aₘ, bₘ, and cₘ are the pairwise self and cross coupling coefficients computed as described in Eq. (8). Specifically, aₘ are the self-coupling coefficients found as the diagonal elements of iP̅, and bₘ and cₘ are the cross-coupling coefficients found as the off-diagonal elements of iP̅. Further, the system adheres to the boundary conditions:

$$\begin{matrix}{\overline{V}}_{0}^{+} ( 0 ) = 1 & ( 14 ) \\ {\overline{V}}_{N}^{-} ( L ) = 0 & ( 15 ) \\ \begin{matrix}{\overline{V}}_{m}^{-} ( L ) = {\overline{V}}_{i - 1}^{+} ( L ) {e}^{{iφ}_{m - 1}} \\ {\overline{V}}_{m}^{+} ( L ) = {\overline{V}}_{m - 1}^{-} ( L ) {e}^{- {iφ}_{m - 1}}\end{matrix} \} for m even & ( 16 ) \\ \begin{matrix}{\overline{V}}_{m}^{-} ( 0 ) = {\overline{V}}_{m - 1}^{+} ( 0 ) {e}^{{iφ}_{m - 1}} \\ {\overline{V}}_{m}^{+} ( 0 ) = {\overline{V}}_{m - 1}^{-} ( 0 ) {e}^{- {iφ}_{m - 1}}\end{matrix} \} for m odd , m > 1 , & ( 17 )\end{matrix}$$

where Φₘ is the phase associated with the bend connecting waveguide m with waveguide m+1. The system of Equations (12, 13), obeying the boundary conditions given by Equations (14-17) was numerically solved for N=9, L=90 μm, and identical waveguides of thickness 220 nm and width 500 nm for gaps g=500 nm, 750 nm, and 1 μm, as well as for a system consisting of alternating waveguides of widths 500 nm and 600 nm with a gap of 500 nm. The phases Φⱼ were all set to zero for simplicity. The results as a function of wavelength are presented in FIG. 10A, which shows the calculated spectra of the folded waveguide structure for 9 identical waveguides with gaps g₁=500 nm, 750 nm, and 1000 nm, and alternating dissimilar waveguides with widths of 500 nm and 600 nm with gap g_{D}=500 nm,

In the case of identical waveguides, there is already significant ripple in the spectrum for a gap of 750 nm and a stop band appears for a gap of 500 nm. With the dissimilar waveguides, however, the ripple in the spectrum for a gap of 500 nm is less than that for the identical waveguides at a gap of 1 μm. The shape of the spectrum depends strongly on the phases Φj, however the degree of ripple in the spectrum does not. The degree of ripple can be characterized by computing the minimum transmission of the folded waveguide structure as the gap between the waveguides was varied. The results of such a simulation are presented in FIG. 10B, which shows the minimum transmission of the folded waveguide structure. It can be seen that for the identical waveguides, the ripple in the spectrum causes the transmission to rapidly fall off for waveguide separations less than approximately 700 nm. On the other hand, the reduction in crosstalk between the dissimilar waveguides effectively keeps the spectrum from developing significant ripple until the waveguide separation (gap) is less than approximately 250 nm, showing a significant reduction in the minimal gap.

Experimental results for sample MZI devices will now be discussed. Michelson interferometer results will be discussed later in this disclosure. Five different MZI devices were fabricated to study the effect of dense dissimilar waveguide routing on the tuning efficiency of MZI switches. MZI Device 1 was used as a baseline device using identical waveguides and a gap of 3 μm to ensure no degradation of the spectrum due to crosstalk. MZI Devices 2 and 3 used dissimilar waveguide routing with a gap of 1 μm, and MZI devices 4 and 5 used dissimilar waveguides with a gap of 0.5 μm for the most dense routing. Table 1 summarizes the parameters of each MZI device. The widths of the waveguides were picked such that adjacent waveguides have a width difference of at least 100 nm and next-to-adjacent waveguides have a width difference of at least 50 nm to protect against any effect of non-nearest neighbor coupling that was not considered in the theoretical analysis. MZI device 1 was fabricated only in an unetched configuration while MZI devices 2-5 were fabricated in both unetched and underetched configurations. It is pointed out that the so called “unetched” MZI devices included isolation trenches at the sides, but were not etched underneath.

TABLE 1
Device parameters

| | De- | De- | De- | De- | De- |
|---|---|---|---|---|---|
| | vice 1 | vice 2 | vice 3 | vice 4 | vice 5 |
| N | 3 | 5 | 5 | 9 | 9 |
| wᵢ | 500, 500 | 500, 400 | 500, 400 | 500, 600, | 500, 600, |
| (nm) | 500 | 550, 650 | 550, 650 | 400 550, | 400 550, |
| | | 500 | 500 | 650, 450 | 650, 450 |
| | | | | 600, 400, | 600, 400, |
| | | | | 500 | 500 |
| g | 3.0 | 1.0 | 1.0 | 0.5 | 0.5 |
| (μm) | | | | | |
| L | 120 | 90 | 290 | 90 | 290 |
| (μm) | | | | | |

These MZI devices were subject to the following experimental procedure. A tunable laser source was used to inject 0 dBm of light through an optical fiber into the chip through transverse electric (TE) grating couplers. After passing through a device, the light exited the chip through a second fiber grating coupler and the transmitted light was passed to a photodetector. The wavelength of the input light was swept from 1530 nm to 1580 nm in 0.1 nm steps and the transmission spectrum of the device was recorded. This procedure was repeated while applying several different current levels to the phase shifter heaters and recording the power supplied.

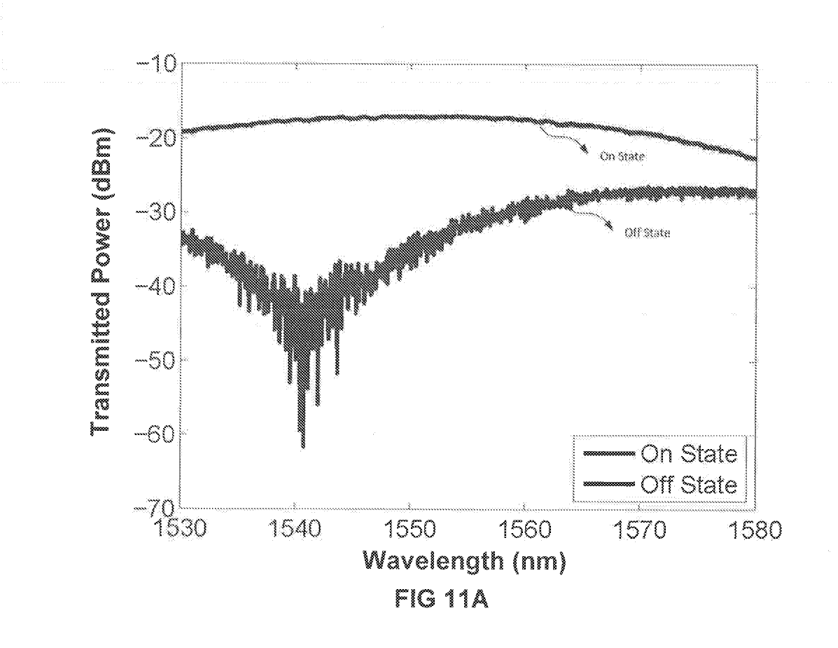

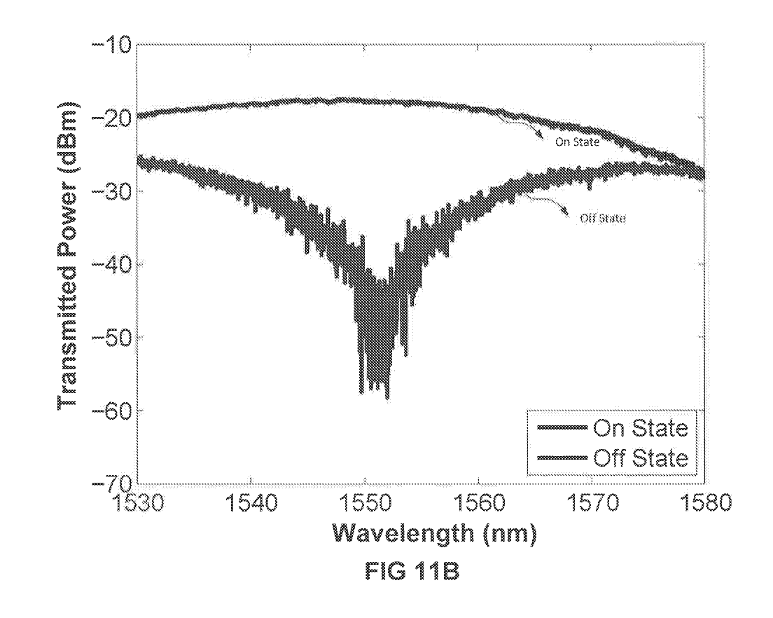

In each case, the extinction ratio of the switch was measured to be greater than 20 dB. FIGS. 11A and 11B show example optical spectra of the underetched versions of MZI devices 3 and 5, respectively, in the on and off state. It can be seen that even for the longest devices tested, the more aggressive waveguide routing density of MZI device 5 compared to MZI device 3 did not have a negative effect on either the extinction ratio of the switch or the ripple in the transmission spectrum, which is maintained at below 0.1 dB peak to peak. This suggests that the dissimilar waveguides have successfully prevented cross-coupling of power in the dense routing regions of the switch. The insertion losses of the switches were estimated to be −0.9 dB, −1 dB, −2.5 dB, −1.2 dB, and −2.9 dB for devices 1-5, respectively. The difference in insertion loss is due to the difference in propagation loss for the different arm path lengths. The insertion loss was found not to depend on whether or not the device was underetched. The envelope of the transmission spectrum in the on state is due to the wavelength-dependent coupling efficiency of the grating couplers used. The wavelength dependence of the extinction ratio is due to an optical length mismatch between the two arms, which is likely due to variations in the thickness of the silicon layer across the wafer. The period of the variations in the extinction ratio could be extended to create a more broadband device by designing a switch such that the average distance between its arms is smaller, at the expense of an increased thermal crosstalk between the arms.

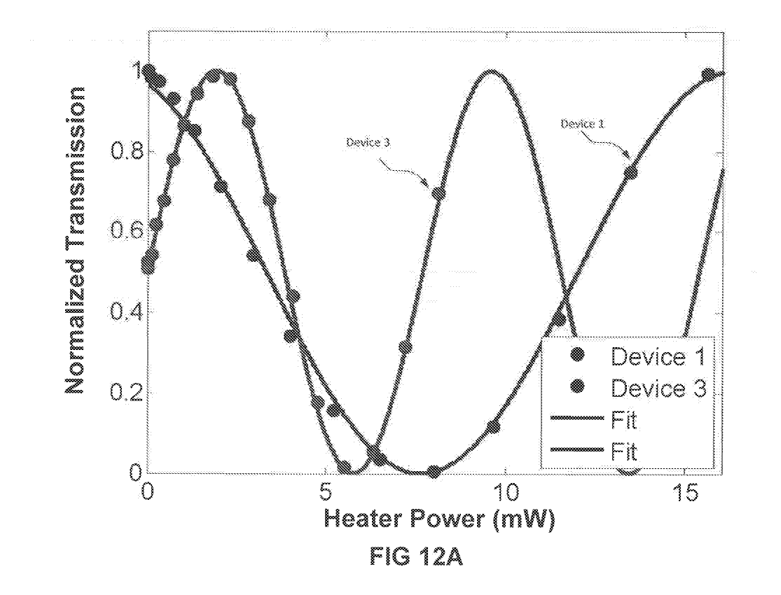

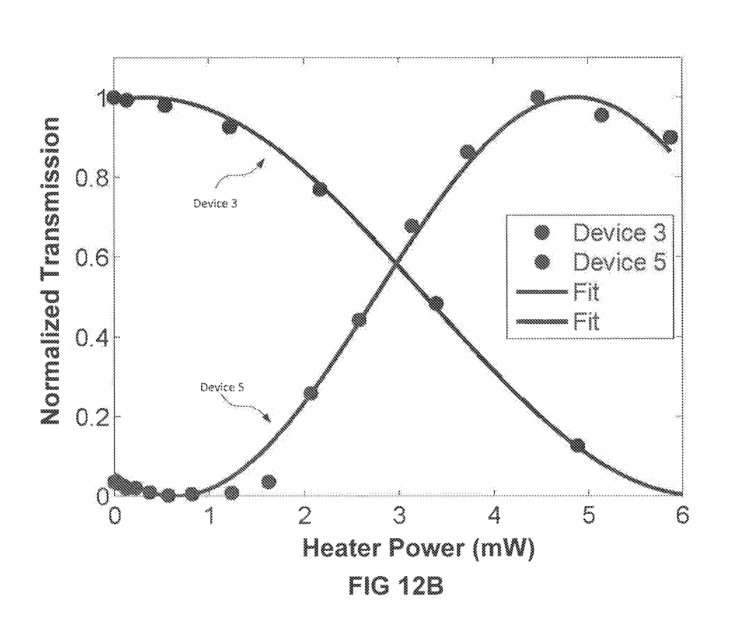

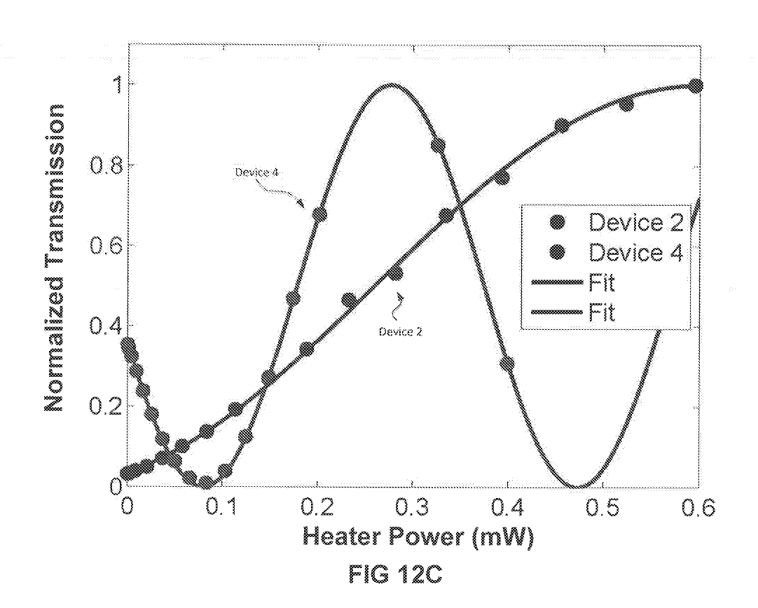

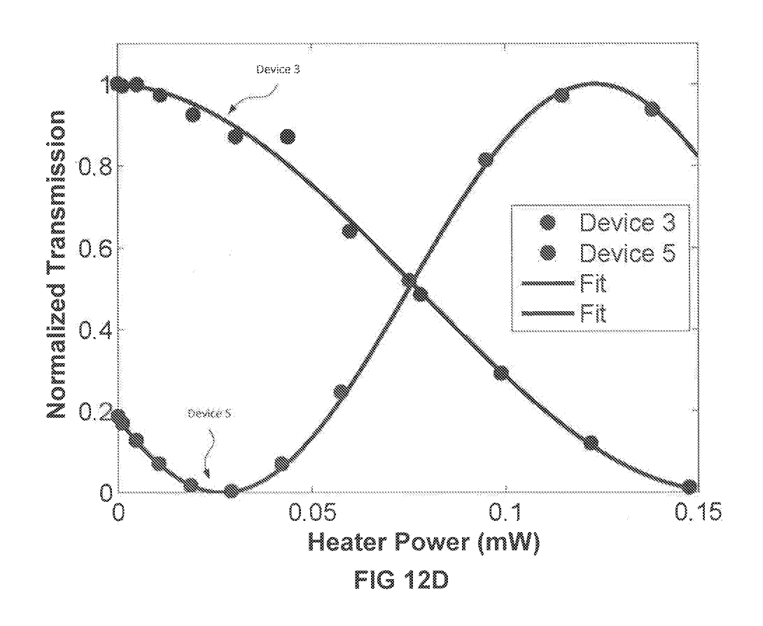

FIGS. 12A-1) show the normalized transmission functions of the unetched and underetched versions of devices 2-5 as functions of the power applied to the thermal phase shifter, along with sinusoidal fits to the data. The wavelength of operation was 1550 nm. It can be seen that in many cases the devices with denser waveguide routing give higher phase shifter efficiency. FIG. 12A illustrates normalized transmission functions of the short (devices 2 and 4) unetched MZI switches. FIG. 12B illustrates normalized transmission functions of the long (devices 3 and 5) unetched MZI switches. FIG. 12C illustrates normalized transmission functions of the short underetched MZI switches. FIG. 12D illustrates normalized transmission functions of the long underetched MZI switches.

TABLE 2
Tuning efficiency of MZI switches

| | De- | De- | De- | De- | De- |
|---|---|---|---|---|---|
| | vice 1 | vice 2 | vice 3 | vice 4 | vice 5 |
| Unetched | 14 | 8.7 | 5.9 | 3.8 | 4.2 |
| | mW/π | mW/π | mW/π | mW/π | mW/π |
| Underetched | N/A | 0.68 | 0.16 | 0.20 | 0.095 |
| | | mW/π | mW/π | mW/π | mW/π |

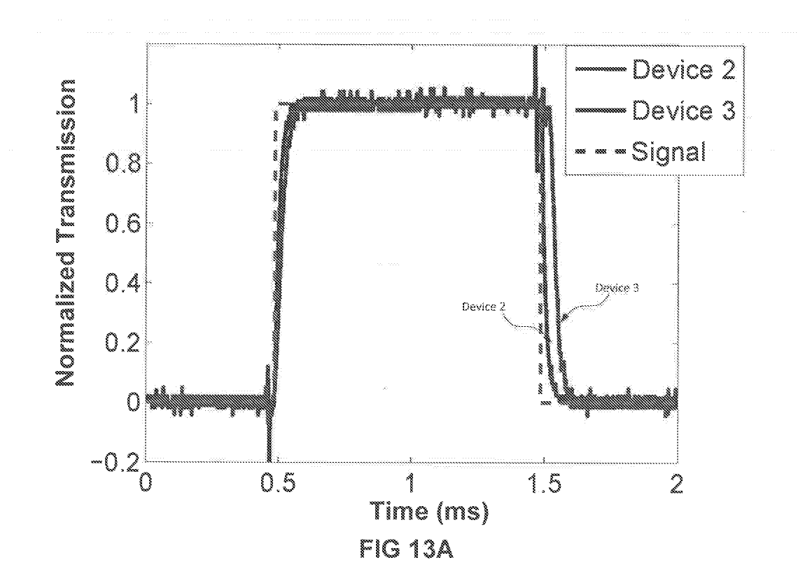

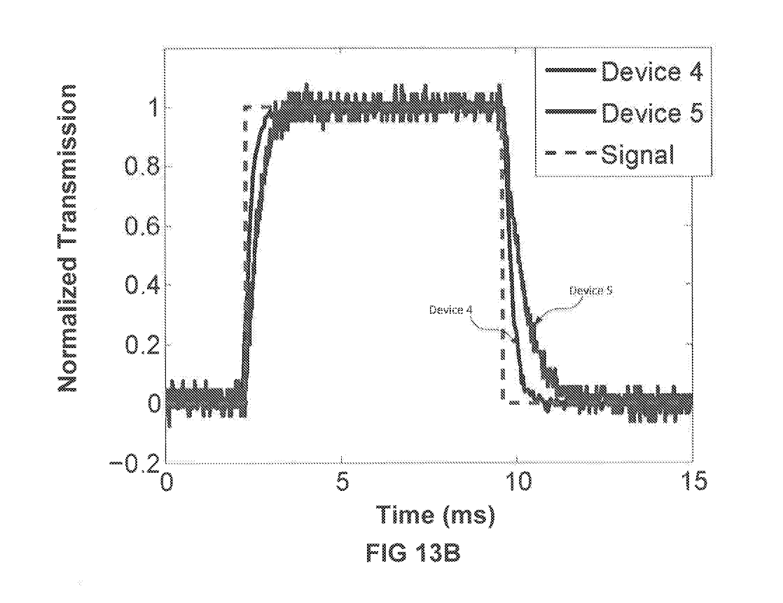

FIGS. 13A-B show the temporal responses of the MZI switches when the heaters were driven with a square pulse. Temporal responses of FIG. 13A were for unetched and FIG. 13B for underetched MZI switches. The temporal response was found not to depend significantly on the waveguide routing density, but only on the heater length and whether or not the device was underetched. This suggests that the increase in device efficiency with increasing waveguide density does not come at the expense of a slower response time. The measured response times are summarized in Table 3. It is clear that the increases in efficiency when underetching devices or increasing device length come with an increase in the response time due to the improved thermal isolation of the heated region from its environment.

TABLE 3
Response times of MZI switches

| | Unetched | Unetched | Underetched | Underetched |
|---|---|---|---|---|
| | Short | Long | Short | Long |
| Rise Time (μs) | 40 | 60 | 550 | 750 |
| Fall Time (μs) | 45 | 65 | 550 | 1200 |

Accordingly, increased waveguide routing density near a heating element is achievable by using dissimilar waveguides, which can be an effective way to improve the efficiency of thermal phase shifters. Utilizing highly dense routing of 9 waveguides under a 10 mm wide heater resulted in an MZI switch with ultra-low switching power of 95 mW while maintaining an extinction ratio greater than 20 dB and ripple in the through response of less than 0.1 dB. The waveguide routing density was found to not impact the switch response time.

Experimental/simulation results using example Michelson Interferometer Configuration (MIC) devices similar to that of FIG. 4 will now be discussed.

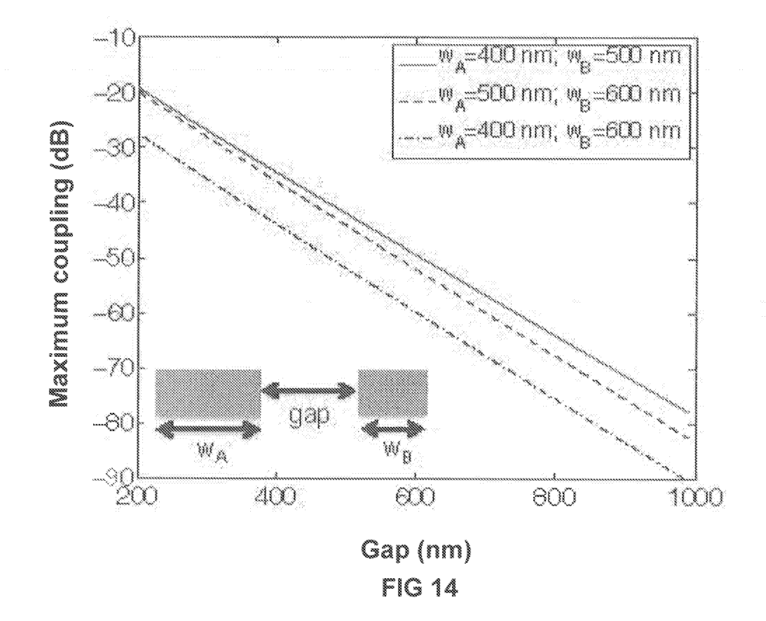

FIG. 14 shows the maximum optimal coupling for 1550 nm light between two dissimilar waveguides with widths of 400 nm, 500 nm, and 600 nm and thickness of 200 nm. The simulation results are calculated using Mode Solutions. As can be seen from FIG. 14, a maximum coupling of less than −30 dB can be obtained for gaps larger than 400 nm.

The phase shift Δφ of the switch can be expressed as:

$$Δϕ = \frac{2 π}{λ} \frac{d n}{d T} Δ T 2 NL \qquad ( 18 )$$

where

$$\frac{d n}{d T} = 1.86 \times {10}^{- 4} {K}^{- 1}$$

is the thermo-optic coefficient of Si and ΔT is the temperature difference between the two arms. N is the number of parallel waveguide sections as shown in FIG. 6. λ is the wavelength. L is the length of the heater, i.e. 249 μm in this embodiment. The Michelson Interferometer Configuration contributes to the phase tuning efficiency by a factor of 2; the thermal isolation of the suspended phase tuning arm contributes to a higher ΔT; the dense folded waveguide contributes to the phase tuning by a factor of N.

A series of MCI test devices were fabricated, as shown in Table 1:

TABLE 1
List of the fabricated test devices

| Device | N | Suspended | g (nm) | wᵢ (nm) | 2 · N · L (mm) |
|---|---|---|---|---|---|
| 1 | 1 | No | NA | w₁ = 500 | 0.498 |
| 2 | 1 | Yes | NA | w₁ = 500 | 0.498 |
| 3 | 7 | No | 1000 | w_{1, 4, 7} = 500, | 3.486 |
| | | | | w_{2, 5} = 600, | |
| | | | | w_{3, 6} = 400 | |
| 4 | 7 | Yes | 1000 | w_{1, 4, 7} = 500, | 3.486 |
| | | | | w_{2, 5} = 600, | |
| | | | | w_{3, 6} = 400 | |
| 5 | 11 | No | 430 | w_{1, 4, 7, 10} = 500, | 5.478 |
| | | | | w_{2, 5, 8, 11} = 600, | |
| | | | | w_{3, 6, 9} = 400 | |
| 6 | 11 | Yes | 430 | w_{1, 4, 7, 10} = 500, | 5.478 |
| | | | | w_{2, 5, 8, 11} = 600, | |
| | | | | w_{3, 6, 9} = 400 | |

2 · N · L is the optical interaction length with the heated region.

The test devices discussed herein were fabricated using a 248 nm process at the Institute of Microelectronics (IME), Singapore. Six different devices were fabricated on the same wafer to investigate the effects of the suspended phase arms and the densely folded waveguides on the tuning efficiency. Table 1 lists the parameters of the fabricated devices. MIC devices 1 and 2 do not use folded waveguides in their phase arms. MIC devices 3 and 4 use N=7 folded waveguides with waveguide gaps of 1 μm. MIC devices 5 and 6 use N=11 folded waveguides with smaller waveguide gaps of 430 nm. On chip grating couplers [22] were used to couple light into an out of the test devices. A pair of grating couplers connected by a short waveguide was also fabricated for calibrating the insertion loss.

To characterize these devices, a polarization maintaining fiber array was used to align with the input/output grating couplers. An Agilent 81600B tunable laser was used as the optical input source, an Agilent 81635A optical power sensor was used as the optical output detect, and a Keithley 2602A dual-channel system source meter was used as the electrical power source for thermal tuning.

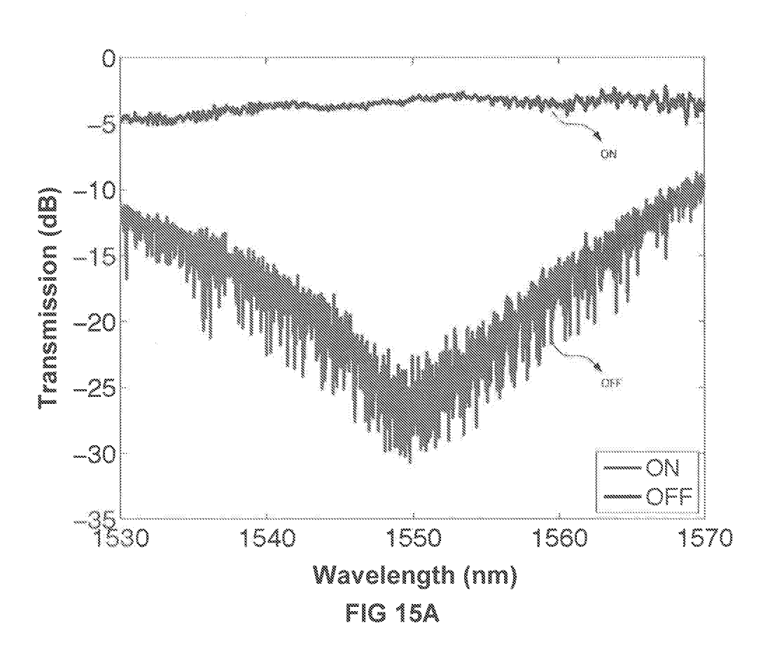

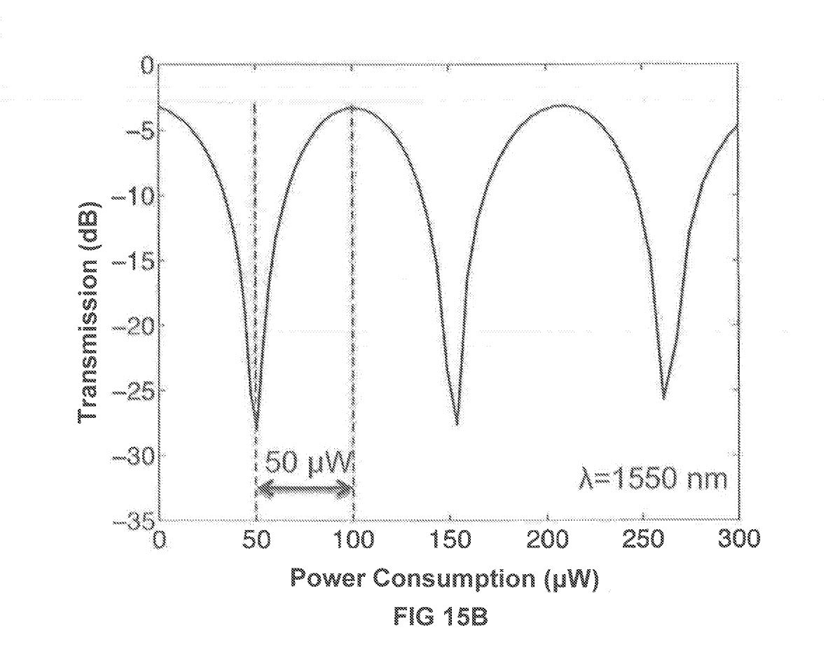

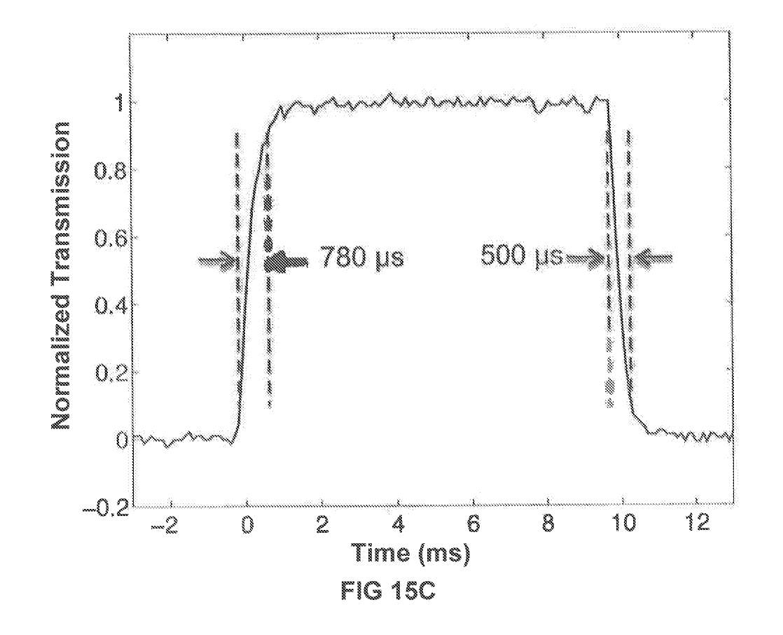

The measured resistances of the metal heaters are approximately 380Ω for all devices. FIG. 15A presents the TE mode transmission at switching ON and OFF states for MIC test device 6. For the same device, the measured insertion loss is 3.3 dB at 1550 nm, which is mainly due to the round-trip propagation loss of the 4.27 mm long phase arms and the waveguide bends. As shown in FIG. 15B, at 1550 nm the measured power to switch from the maximum to minimum transmission is 50 μW, and the switching extinction ratio is 26 dB. FIG. 15C shows the 10%-90% response time for MIC device 6 is 1.28 ms, including a 780 μs rise time and a 500 μs fall time.

For comparison, measurement results for all test devices are shown in FIGS. 16A and 16B. As shown in FIG. 16A, the power consumption of the devices significantly decreases when increasing the number of folds N in the waveguide, which is consistent with expectations from equation (18) above. To be clear, there are N parallel portions of the waveguide, with N−1 bends.

When comparing the devices with suspended structures to those without, the suspended structures demonstrated 1/35^{th} of the previous consumption. As shown in FIG. 16B, increasing the number of waveguides does not significantly influence the response time of the devices. However, the response time of the devices with suspended structures is approximately 6 times slower than that of those without. For thermally isolated structures, there is a tradeoff between efficiency and response time, however the improvement in efficiency (35×) will likely be worth the degradation of response time (6×) for many applications.

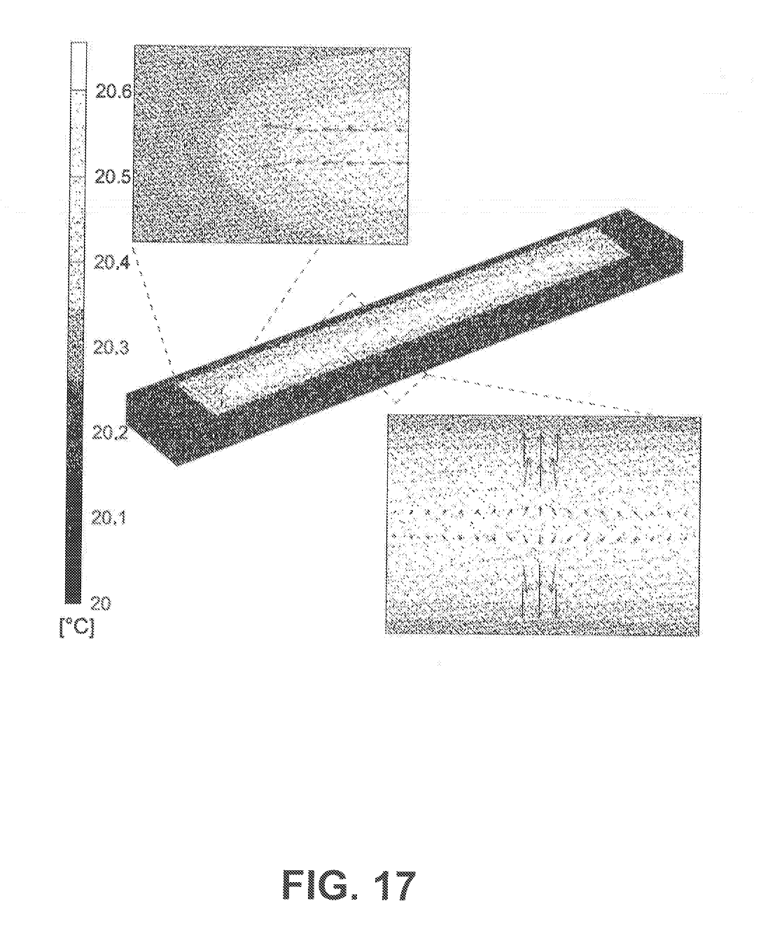

Further improvements can be made to further reduce the power consumption according to some embodiments. FIG. 17 shows a simulated 3D temperature distribution in the suspended arm of MIC device 6 when a power of 50 μW is supplied to the heater. This simulation has been obtained through a 3D heat transfer simulation. The two ends of the arm and the small support bridges between the isolation trenches have been found to be the major outlets of leaking heat. As a result, having a longer suspended arm and fewer bridges may improve thermal isolation, and thus further reduce the power consumption of the switches. Additionally, thermal isolation can be applied to the second arm of the interferometer to further reduce the thermal crosstalk between the arms.

Accordingly, photonic ultra-efficient thermo-optic switches on a 220 nm silicon-on-insulator (SOI) platform have been demonstrated. Folded waveguides in a Michelson Interferometer Configuration can be used to increase the optical interaction length of the light with the heated region, and a suspended structure can be used to improve thermal isolation. An ultra-low switching power of 50 μW is realized with an extinction ratio of over 26 dB for the transverse electric (TE) mode at 1550 nm. The 10%-90% response time of the switch is 1.28 ms, including a 780 μs rise time and a 500 μs fall time. These results demonstrate a significant reduction in power consumption compared to prior art devices.

It should be appreciated that the techniques suggested herein can be extended to other switching architectures where low power switching is desired.

Although the present disclosure has been described with reference to specific features and embodiments thereof, it is evident that various modifications and combinations can be made thereto without departing from the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

1. An optical device comprising:
first and second waveguide phase arms each having optically coupled parallel sections of waveguides, the parallel sections of each one of the first and second waveguide phase arms being dissimilar to lessen crosstalk; and
a tunable element for applying a phase shift to an optical signal traversing the first waveguide phase arm.

2. The optical device as claimed in claim 1 wherein each optically coupled parallel section of waveguides forms a single lightpath.

3. The optical device as claimed in claim 2 wherein the waveguides of the parallel sections have dissimilar dimensions.

4. The optical device as claimed in claim 2 wherein adjacent waveguides of the parallel sections vary in one or more of gap, width, and/or thickness.

5. The optical device as claimed in claim 4 wherein the first and second waveguide phase arms comprise a plurality of tapered waveguides of different dimensions which are connected by loops, and the loops form transitions between the different dimensions.

6. The optical device as claimed in claim 5 wherein there are N parallel sections and N−1 loops, with N being an odd integer greater than or equal to 3, such that input and output signals in each one of the first and second waveguide phase arms travel in a same direction.

7. The optical device as claimed in claim 4 wherein the tunable element comprises a thermo-optic heater thermally coupled to the first waveguide phase arm.

8. The optical device as claimed in claim 7 wherein the optical device is a silicon photonic device, and wherein the thermo-optic heater comprises a metallic layer.

9. The optical device as claimed in claim 7 wherein the first waveguide phase arm is suspended for better thermal isolation thereof.

10. The optical device as claimed in claim 8 wherein the optical device in the region of the thermo-optic heater is underetched to improve thermal isolation of the first waveguide phase arm adjacent the thermo-optic heater.

11. The optical device as claimed in claim 4 further comprising a coupler configured as both an input power splitter for splitting an input optical signal between the first and second waveguide phase arms, and as an output power combiner for recombining optical signals from the first and second waveguide phase arms to produce an output optical signal.

12. The optical device as claimed in claim 11 wherein the optical device is configured as a Michelson interferometer, and wherein the first and second waveguide phase arms are terminated with waveguide reflectors at ends of the first and second waveguide phase arms.

13. The optical device as claimed in claim 12 wherein the one or more couplers comprise a 2×2 coupler selected from a group consisting of an adiabatic coupler, a multimode interference (MMI) coupler, and a directional coupler.

14. The optical device as claimed in claim 12 wherein the waveguide reflectors comprise loop mirrors.

15. The optical device as claimed in claim 14 wherein the loop mirror comprises a compact Y-branch and a bent waveguide.

16. The optical device as claimed in claim 4 wherein the optical device is configured as a thermo-optic switch.

17. The optical device as claimed in claim 16 further comprising one or more couplers configured as input power splitters for splitting an input optical signal between the first and second waveguide phase arms, or as output power combiners for recombining the optical signal from the first and second waveguide phase arms to produce an output optical signal.

18. The optical device as claimed in claim 17 wherein the optical device is configured as a tunable Mach-Zehnder interferometer based optical switch.

19. The optical device as claimed in claim 18 wherein the optical device is configured as a modulator.

20. The optical device as claimed in claim 2 wherein the optical device is configured as a tunable Mach-Zehnder interferometer wherein at least adjacent waveguides of the parallel sections have varying widths.
